(19) United States
(12) Patent Application Publication
(10) Pub. No.: US 2025/0081252 A1
(43) Pub. Date: Mar. 6, 2025

(54) PAIRING AUDIO DEVICE(S) WITH AN ENDPOINT OVER A NETWORK

(71) Applicant: Cisco Technology, Inc., San Jose, CA (US)

(72) Inventor: Sigurd Klasson, Oslo (NO)

(21) Appl. No.: 18/240,216

(22) Filed: Aug. 30, 2023

(51) Int. Cl. H04W 76/10; H04M 3/56

(52) U.S. Cl. CPC H04W 76/10; H04M 3/568

(57) ABSTRACT

A first device determines, within an environment, a device type of a second device within the environment. The first device determines, based at least in part on the device type, to output first data via a speaker of the first device or a display of the first device. Therein, the first device outputs of the first data via the speaker or the display, and receives, via a network, second data from the second device. The second data is associated with audio generated via a microphone of the second device or an input provided to an input component of the second device. The first data may determine a similarity between the first data and the second data, and based at least in part on the similarity, to pair the first device and the second device.

### TECHNICAL FIELD

The present disclosure relates generally to pairing devices over a network, such as an endpoint hosting or presenting a meeting, with audio device(s) for capturing audio within an environment.

### BACKGROUND

Teleconferencing, or meetings, are used to connect individuals and businesses. Participants may join a meeting using a plurality of devices and, in some instances, microphone(s) may be placed throughout an environment for capturing audio, such as speech. Pairing the microphone(s) with the proper devices, such as a video conferencing display, is often a tedious and/or time consuming process. For example, it may be difficult to disambiguate which microphone(s) are to be paired. Additionally, pairing multiple microphone(s) with the same device may be unobtainable.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment including an endpoint, and one or more audio device(s) configured to be paired with the endpoint via a network, according to examples of the present disclosure.

FIG. 2 illustrates an example component diagram of the endpoint of FIG. 1, according to examples of the present disclosure.

FIG. 3 illustrates an example component diagram of the audio device of FIG. 1, according to examples of the present disclosure.

FIGS. 4A and 4B illustrate an example sequence of outputting a series of prompts on the endpoint of FIG. 1 for pairing the audio device(s) with the endpoint, according to examples of the present disclosure.

FIG. 5 illustrates an example process for pairing the endpoint of FIG. 1 with the audio device(s), according to examples of the present disclosure.

FIG. 6 illustrates an example process for pairing the endpoint of FIG. 1 with the audio device(s), according to examples of the present disclosure.

FIG. 7 illustrates an example process for pairing the endpoint of FIG. 1 with the audio device(s), according to examples of the present disclosure.

FIG. 8 illustrates an example process for pairing the endpoint of FIG. 1 with the audio device(s), according to examples of the present disclosure.

FIG. 9 illustrates an example computer architecture diagram showing an illustrative computer hardware architecture for implementing a server device that may be utilized to implement aspects of the various technologies presented herein, according to examples of the present disclosure.

### DESCRIPTION OF EXAMPLE EMBODIMENTS

### Overview

A method to perform techniques described herein may include causing output of an signal via a first device within an environment, where the first device is connected to a network. The techniques may also include receiving, from a second device within the environment, first data associated with the signal, where the second device is connected to the network. The techniques may also include determining a similarity between the signal represented within the first data and the signal output from the first device, determining that the similarity satisfies a threshold, and determining, based at least in part on the similarity satisfying the threshold, to pair the first device and the second device. The techniques further include receiving, from the second device, second data associated with speech captured within the environment, and sending, over the network and to a third device remote from the environment, third data associated with the speech.

A first device to perform techniques described herein may include a display, a speaker, determining a device type of a second device within an environment of the first device, and based at least in part on the device type, one of causing, via the speaker, output of first audio, or causing, via the display, output of one or more prompts associated with providing input to an input component of the second device. The techniques may further include receiving, via a network, data associated with one of second audio captured at the second device, or the input provided to the input component of the second device. The techniques may also include determining, based at least in part on the data, to associate the first device and the second device.

A method to perform techniques described herein may include determining, via a first device within an environment, a device type of a second device within the environment, determining, based at least in part on the device type, to output first data via a speaker of the first device or a display of the first device, and causing output of the first data via the speaker or the display. The techniques may further include receiving, via a network, second data from the second device, where the second data is associated with audio generated via a microphone of the second device or an input provided to an input component of the second device, determining a similarity between the first data and the second data, and determining, based at least in part on the similarity, to pair the first device and the second device.

### Example Embodiments

This application is directed, at least in part, to systems and methods for pairing an audio device having microphone(s) with an endpoint using signals (e.g., ultrasonic signals, Bluetooth tokens, ultrawideband (UWB), etc.) and/or a series of prompts. The endpoint may represent a device hosting or displaying a meeting, conference, etc., and may output content (e.g., audio, displays, etc.) within an environment. One or more of the audio devices may be disposed throughout the environment in which the endpoint resides for capturing audio (e.g., speech) from participants. Initially, and in some instances, to pair the audio devices with the endpoint, the endpoint may output ultrasonic signal(s) and/or a series of prompt(s) for prompting the participants to pair the audio devices. Other signals, however, such as Bluetooth tokens or UWB signals, for example, may be output by the endpoint and used for pairing. In the case of using the ultrasonic signal(s), the audio device may include microphone(s) for capturing the ultrasonic signal(s) output from the endpoint and may generate data associated with the ultrasonic signal(s). The data may be sent from the audio device to the endpoint via a network. If the ultrasonic signal(s) as captured by the audio device is similar to the ultrasonic signal(s) as output by the endpoint, the audio device may be paired with the endpoint. Additionally, or alternatively, the series of prompt(s) may instruct the participant to provide inputs to a button, toggle, switch, etc. located on the audio device for certain periods of time, according to a certain sequence, and so forth. Therein, the audio device may transmit data to the endpoint via the network, which in turn, may compare the inputs receive at the audio device with the series of prompt(s) output by the endpoint. If the inputs are similar to the prompt(s), the audio device may be paired with the endpoint. As such, using the ultrasonic signal(s) and/or the series of prompt(s), the audio device may be paired with an intended endpoint on the network.

In some instances, the audio device may represent a suitable device having limited functionality. In some instances, the audio device may be considered a headless device. The audio device may include microphone(s) for capturing audio (e.g., speech, sound within the environment, etc.) associated with the participants, and a button, toggle, switch, etc. for allowing the participants to at least partially control an operation of the audio device (e.g., mute, volume up, volume down, pair, etc.). The microphones may also capture the ultrasonic signal(s). Accordingly, the microphones may capture audio that is audible to the participants (e.g., below 20 kilohertz (kHz)) and audio that is inaudible to the participants (e.g., above 20 kHz). The audio device may therefore act as an extension of the endpoint for capturing audio associated with the conference, for providing the audio to other participants. In some instances, however, the audio device may have increased functionality, and include, for example, Bluetooth radios, UWB radios, and so forth for receiving corresponding Bluetooth signals, UWB signals, etc. from the endpoint.

The audio device may also include lighting element(s) that illuminate to different appearance states based at least in part on operations being performed by the audio device. For example, based on a press of the button, the lighting element(s) may illuminate to different colors. In some instances, the audio device may not include radio(s), transceiver(s), etc. for communicating with other devices. Instead, the audio device may include a PoE connection (e.g., port) for powering components of the audio device and connecting the audio device to the network in order to send and receive data to devices on the network. In some instances, the audio device may be powered using mains power, battery(ies), etc., and in such instances, may or may not communicatively connected to the network via PoE. For example, the audio device may couple to the network via an Ethernet port disposed within the environment. In some instances, the audio device may be considered an AoIP microphone.

The endpoint may represent any suitable device configured to output content within the environment. Compared to the audio device, the endpoint may have increased functionalities and capabilities. For example, the endpoint represent a device having display(s), speaker(s), etc. that output the content (e.g., visual, audible, etc.) within the environment. The endpoint may also have microphone(s), camera(s), etc. for capturing content (e.g., feeds, speech, etc.) within the environment. The endpoint may communicatively couple to other devices, whether within or remote from the environment via the network. In some instances, the endpoint may include suitable radios, network interface, etc. for communicating over the network and/or with other devices. For example, the endpoint may include a Bluetooth radio, UWB radio, etc. for sending signals for receipt by the audio device.

In some instances, whether the audio device(s) are paired with the endpoint using ultrasonic signal(s) and/or the series of prompt(s) may be based at least in part on specifics of the endpoint and/or the audio device. For example, the endpoint may output the ultrasonic signal(s) and/or the series of the prompt(s) based at least in part on a manufacturer of the endpoint and/or the audio device. In some instances, the endpoint may determine whether a manufacturer of the endpoint and the audio device are similar, and if so, may pair the endpoint and the audio device using the ultrasonic signal(s). Comparatively, if the manufacturer of the endpoint and the audio device are different, the endpoint and the audio device may be paired using the series of prompt(s).

In some instances, to determine the manufacturer of the audio device, the endpoint may output a prompt on the display. For example, the display may output an indication associated with whether the audio device is of a certain manufacturer. Using speech, touch input, or a remote control associated with the endpoint, the participant may select a corresponding response. As an alternative example, the endpoint may determine security layers, configurations, or settings of the audio device(s) within the environment. In this example, a similar manufacture of the endpoint and the audio device may have like security layers, configurations, and/or settings, and such information may be used to deduce whether the manufacturers of the audio device(s) and the endpoint are similar. Further, as another example, the endpoint may discover device(s) within the environment, as a part of a discovery process, for obtaining information about a device type of the audio device(s). Using the device type, the endpoint may determine the manufacturer of the audio device.

Although described herein as using a manufacturer of the audio device for determining whether to output the ultrasonic signal(s) and/or the series of prompt(s), other characteristics may be used. For example, whether the endpoint outputs the ultrasonic signal(s) and/or the series of the prompt(s) may be based at least in part on a number of audio devices to be paired with the endpoint, functionalities of the audio device and/or the endpoint, and so forth. Regardless of specific implementation, in some instances, the participants may provide inputs to the endpoint (e.g., remote control, touch input, speech, etc.) and/or the audio device as to whether endpoint and the audio device are to be paired via the ultrasonic signal(s) and/or the series of the prompt(s), or the endpoint may determine, without input from the participant, whether endpoint and the audio device are to be paired via the ultrasonic signal(s) and/or the series of the prompt(s).

In some instances, in order to pair the audio device and the endpoint, the audio device may first be connected to an Ethernet port within the environment. For example, Ethernet ports may be disposed throughout the environment (e.g., on walls, desks, etc.), and the audio device may be connected to the Ethernet port via an Ethernet cable (e.g., Cat5, Cat 6, Cat 7, etc.). The environment may include any number of Ethernet port(s). Noted above, such connection provides power to the audio device and connects the audio device to the network. In response to being connected to the Ethernet port, or the network, the audio device may enter a setup mode and/or the lighting element(s) (e.g., light emitting diode (LED)) of the audio device may illuminate, output a series of displays via the lighting elements (e.g., blinking, on/off sequence, etc.), and so forth. In the setup mode, the audio device may connect to the network, may be discoverable by the endpoint, and/or may enable the microphone(s) to receive the ultrasonic signal(s) from the endpoint. In other instances, to enter the setup mode, one or more button(s) of the audio device may be depressed for a certain period of time (e.g., reset). In some instances, once in setup mode, the participant may interact with the endpoint for causing the ultrasonic signal(s) to be emitted and/or the series of prompt(s) to be output. For example, the participant may interact with the endpoint to enter a pairing process with the audio device (e.g., via menus, drop downs, speech, etc.).

To pair the audio device with the endpoint using ultrasonic signal(s), the endpoint may output the ultrasonic signal(s) via speaker(s) of the endpoint. As used herein, ultrasonic signal(s) may represent inaudible sound waves having a frequency of 20 kHz or greater. At this frequency range, the ultrasonic signal(s) are inaudible to humans. The microphone(s) of the audio device may capture the ultrasonic signal(s) and generate corresponding data (e.g., audio data). The audio device may therein send data that contains at least a portion of the audio data through the network and to the endpoint. Upon receipt, the endpoint may compare the ultrasonic signal(s), as emitted, with the ultrasonic signal(s) referenced within the data. If the ultrasonic signal(s) are similar, the audio device and the endpoint may be paired. For example, the endpoint may compare pitches, tones, wavelengths, etc. within the ultrasonic signal(s) as captured by the audio device with the ultrasonic signal as emitted via the endpoint. In some instances, if the ultrasonic signal(s) are similar by a threshold amount (e.g., ninety percent) the endpoint and the audio device may be paired.

In some instances, the ultrasonic signal(s) may also include (e.g., embedded with, contain metadata, etc.) an IP address of the endpoint, a device identifier of the endpoint, a media access control (MAC) address of the endpoint, and so forth. Moreover, the audio device may also transmit an IP address of the audio device, a device identifier of the audio device, a MAC address of the audio device, and so forth within the data. This additional information may be used to pair the audio device with the endpoint and/or direct or otherwise route the data to the specific endpoint on the network. For example, a given network may have a plurality of audio devices, endpoints, as well as other devices (e.g., servers, etc.), and to ensure that the data is routed to an intended device on the network, such information may be used. For example, using the device identifier of the endpoint, the data containing the ultrasonic signal(s) may be routed accordingly. In other instances, the data may be routed to the endpoint based on knowing which of the endpoints on the network are in pairing mode (e.g., which endpoints are pairing with the audio devices). That is, certain endpoints that are in pairing mode may be used to deduce where the data should be routed. As such, the data may be routed from the audio device to the endpoint.

Although the discussion up to this point is with regard to using ultrasonic signal(s) to pair the audio device and the endpoint, in some instances, the endpoint may output Bluetooth signals (or data) and/or UWB signals (or data) for pairing with the audio device. To receive the signals, the audio device includes corresponding radios. Upon receipt of the signal from the endpoint, the audio device may transmit a signal back to the endpoint via the corresponding radio, or may transmit a signal back to the endpoint via the network. The signal received at the audio device may include a device identifier of the endpoint, and the signal sent to the endpoint may include a device identifier of the audio device. Using these two device identifiers, the endpoint and the audio device may be paired with one another.

To pair the audio device with the endpoint using the series of prompts, the endpoint may output the series of prompt(s) via the display. In some instances, the series of prompts may include descriptions of when to provide input (e.g., depress) to a button of the audio device. For example, the prompt(s) may indicate when to press and hold down the button. In some instances, the button in which the participant provides input may be associated with a mute button, on/off button, etc. of the audio device. In some instances, the series of prompt(s) may be displayed prior to, during, and/or after the participant provides the input. For example, the endpoint may display a countdown to inform the participant of when to depress the button for pairing the audio device with the endpoint. As the participant provides the input, the display may also display how long, or for how much longer, the participant is to provide the input.

In some instances, the series of prompt(s) as displayed by the endpoint may be associated with a unique pattern or sequence of when the participant is to press, as well as for how long the participant is to press, the button. For example, the series of prompt(s) may include hold down times that may range from one second, to a couple seconds, to several seconds. In some instances, the hold down times may be randomized and unique to the series of prompt(s), the endpoint, and/or the audio device. For example, the series of prompt(s) may instruct the participant to press and hold the button for three seconds, release the button for one second, press and hold the button for two seconds, release the button for two seconds, and then to press and hold the button for four seconds. During these series of prompt(s), the endpoint may display a countdown (e.g., timer) of three seconds, one second, two seconds, two seconds, and four seconds, respectively, to guide the participant as to when to press and release the button. That is, the participant may know when, and for how long, to depress and release the button. Any number of prompt(s) may be output via the endpoint.

As the participant depresses the button, the lighting elements of the audio device may correspondingly illuminate. For example, during the setup process (as described above), the lighting elements may illuminate to a first color (e.g., blue), and then based on receiving the input, may illuminate to a second color (e.g., green). The audio device, in response to the inputs at the button, generates data that indicates the series of inputs provided to the button. The data may then be transmitted to the endpoint via the network. Noted above, in some instances, given that the network may have a plurality of audio devices, endpoints, as well as other device(s), to ensure that the data is routed to an intended recipient on the network, knowing which of the endpoints are in pairing mode may be used to deduce where the data should be routed. In other instances, device identifiers may be used to route the data accordingly. Upon receipt of the data, the endpoint may compare the inputs provided at the audio device to determine whether to pair with the audio device. For example, if the data indicates that the participant pressed and held the button for three seconds, released the button for one second, pressed and held the button for two seconds, released the button for two seconds, and then pressed and held the button for four seconds, the endpoint may determine that the inputs at the audio device are similar to the series of prompt(s). Accordingly, if the participant performs the series of prompt(s) as instructed, the audio device and the endpoint may be paired. In some instances, the audio device may also transmit an IP address of the audio device, a device identifier of the audio device, a MAC address of the audio device, and so forth to additionally pair the endpoint and the audio device.

Although the series of prompt(s) are described as being displayed on the endpoint, in some instances, the series of prompt(s) may be output on a speaker of the endpoint. Here, the speakers may output instructions as to when to press and hold the button, and may include a countdown as to a remaining portion of time to depress the button. For example, the endpoint may output “hold down the button for three seconds,” “hold down the button for one more second,” “release the button,” etc. The speakers and the display may also output the series of prompt(s) simultaneously.

After pairing the audio device and the endpoint, the audio device may begin capturing audio data and may then send the audio data to the endpoint. That is, after connecting the audio device and the endpoint, the audio device and the endpoint may be connected via the network. In doing so, the endpoint, or another communicatively connected device may then distribute audio data to other participants within the conference, meeting, etc. Further, the audio data as captured may be used to generate a recording, transcript, etc. of the meeting.

In some instances, the environment may include any number of audio devices having one or more microphones. In some instances, the audio devices may be individually paired with the endpoint, or may be collectively paired with the endpoint. For example, one by one, the audio devices may be paired to the endpoint. In some instances, pairing the audio devices individually may be used to set a position (e.g., location) of the audio devices within the environment. To pair the audio devices collectively with the endpoint, the audio devices may generate audio data indicative of the ultrasonic signal(s), respectively, for sending to the endpoint for comparison. That is, if several audio devices transmit the ultrasonic signal(s) back to the endpoint through the network, those audio devices may be paired to the endpoint. Comparatively, in some instances, if more than one audio device is to be paired with the endpoint, then the series of prompt(s) may be output on the endpoint. Here, in some instances, one by one, the audio devices may be paired with the endpoint.

Although described as connecting the endpoint with the audio devices via ultrasonic signal(s) and/or inputs provided to the buttons, other forms are envisioned. For example, the endpoint may provide a one-time code, one-time password, etc., and the participant may provide the one-time code, one-time password, etc. to the audio device. Further, in some instances, the participants may authenticate themselves (e.g., speech recognition, voice recognition, multi-factor authentication, etc.) in order to pair the audio devices with the endpoint.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting embodiments. The features illustrated or described in connection with one embodiment may be combined with the features of other embodiments. Such modifications and variations are intended to be included within the scope of the appended claims.

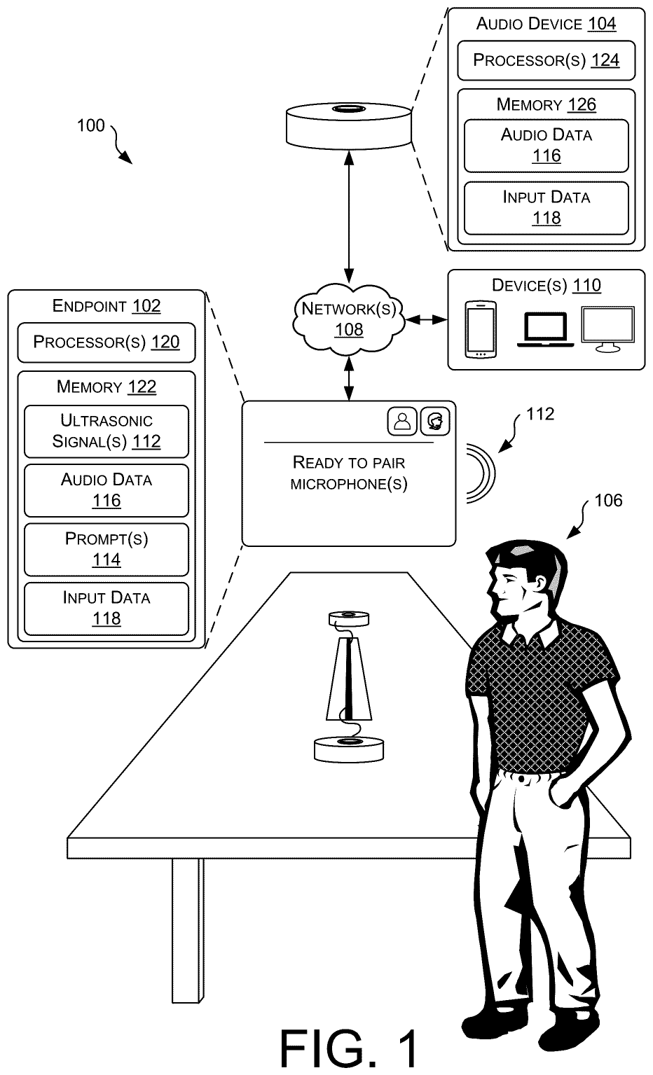

FIG. 1 illustrates an example environment 100 including an endpoint 102 and an audio device 104, according to examples of the present disclosure. The environment 100 may represent any suitable environment in which a meeting, conference, etc. is held amongst one or more participants 106. Any number of participants 106 may be included within the environment 100, and the participants 106 may be located in other environments. In such instances, and as will be explained herein, the endpoint 102 may communicatively connect the participants 106 across environments.

The endpoint 102 may represent any suitable device configured to output content within the environment 100. For example, the endpoint 102 may represent a device having display(s), speaker(s), etc. that output the content (e.g., visual, audible, etc.) within the environment 100. The endpoint 102 may also have microphone(s), camera(s), etc. for capturing content (e.g., feeds, speech, etc.) within the environment 100. The endpoint 102 may communicatively couple to other device(s), whether within or remote from the environment 100 via network(s) 108. Details of the endpoint 102 are discussed herein, however, the endpoint 102 may communicatively connect to the audio device 104 within the environment 100, via the network(s) 108, as well as other device(s) 110 remote from the environment 100. For example, additional participants 106 may be remote from the environment 100, but engaged with the conference via respective device(s) 110. In such instances, the endpoint 102, or the network(s) 108, may be configured to distribute data (e.g., audio) as captured from the audio device 104, for example, to the device(s) 110 for output. Suitable device(s) 110 include mobile devices, laptops, displays, etc.

The audio device 104 may include microphone(s) for capturing audio (e.g., speech) associated with the participants 106, and a button, toggle, switch, etc. for allowing the participants 106 to at least partially control an operation of the audio device 104 (e.g., mute, volume up, volume down, pair, etc.). The audio device 104 may therefore act as an extension of the endpoint 102 for capturing audio associated with the conference, for providing the audio to other participants 106.

The audio device 104 may also include a PoE connection (e.g., port) for powering components of the audio device 104 and connecting the audio device 104 to the network(s) 108 in order to send and receive data to devices on the network(s) 108, such as the endpoint and the device(s) 110. For example, the audio device 104 may couple to the network(s) 108 via an Ethernet port disposed within the environment 100. In some instances, the audio device 104 may be considered an AoIP microphone, and in some instances, may represent a simple device having limited functionality.

The audio device 104 is configured to capture audio, such as speech of the participants 106, for providing the audio to other participants 106 in the meeting (e.g., remote from the environment 100). Initially, however, the audio device 104 may be paired with the endpoint 102 in order to associate the audio device 104 with the endpoint 102. In some instances, to pair the audio device 104 with the endpoint 102, the endpoint 102 may output ultrasonic signal(s) 112 and/or a series of prompt(s) 114 on the display of the endpoint 102. In some instances, whether the audio device 104 is paired with the endpoint 102 using ultrasonic signal(s) 112 and/or the series of prompt(s) 114 may be based at least in part on specifics of the endpoint 102 and/or the audio device 104. For example, the endpoint 102 may output the ultrasonic signal(s) 112 and/or the series of the prompt(s) 114 based at least in part on a manufacturer of the endpoint 102 and/or the audio device 104. In some instances, the endpoint 102 may determine whether a manufacturer of the endpoint 102 and the audio device 104 are similar, and if so, may pair the endpoint 102 and the audio device 104 using the ultrasonic signal(s) 112. Comparatively, if the manufacturer of the endpoint 102 and the audio device 104 are different, the endpoint 102 and the audio device 104 may be paired using the series of prompt(s) 114. Additionally, or alternatively, whether the endpoint 102 and the audio device 104 are paired using the ultrasonic signal(s) 112 and/or the series of the prompt(s) 114 may be based at least in part on a number of audio devices 104 to be paired with the endpoint 102, functionalities of the audio device 104 and/or the endpoint 102, security layers, configurations, or settings of the audio device 104 and/or the endpoint 102, and so forth.

Initially, to pair the audio device 104 and the endpoint 102, the audio device 104 may first be connected to an Ethernet port within the environment 100. For example, Ethernet ports may be disposed throughout the environment 100, and the audio device 104 may be connected to the Ethernet port via an Ethernet cable (e.g., Cat5, Cat 6, Cat 7, etc.) The environment 100 may include any number of Ethernet port(s). Such connection provides power to the audio device 104 and connects the audio device 104 to the network(s) 108. In response to being connected to the Ethernet port, or the network(s) 108, the audio device 104 may enter a setup mode and/or lighting elements of the audio device 104 may illuminate. In the setup mode, the audio device 104 may connect to the network(s) 108, may be discoverable by the endpoint 102, and/or may enable the microphone(s) to receive the ultrasonic signal(s) 112 from the endpoint 102. In some instances, once the audio device 104 is in setup mode, the participant 106 may interact with the endpoint 102 for causing the ultrasonic signal(s) 112 to be emitted and/or the series of prompt(s) 114 to be output.

In the case of using the ultrasonic signal(s) 112, microphone(s) of the audio device 104 may capture the ultrasonic signal(s) 112 and generate corresponding audio data 116. The microphone may therefore be configured to capture audio that is audible and inaudible to the participants 106. The audio device 104 may therein send data that contains at least a portion of the audio data 116 through the network(s) 108 to the endpoint 102. Upon receipt, the endpoint 102 may compare the ultrasonic signal(s) 112, as emitted, with the ultrasonic signal(s) 112 referenced within the audio data 116. If the ultrasonic signal(s) 112 are similar, the audio device 104 and the endpoint 102 may be paired. For example, the endpoint 102 may compare pitches, tones, wavelengths, etc. within the ultrasonic signal(s) 112 as captured by the audio device 104 with the ultrasonic signal(s) 112 as emitted via the endpoint 102. In some instances, if the audio data 116 and the ultrasonic signal(s) 112 are similar by a threshold amount the endpoint 102 and the audio device 104 may be paired.

In the case of using the series of prompt(s) 114, the endpoint 102 may output the series of prompt(s) 114 via the display of the endpoint 102. In some instances, the series of prompt(s) 114 may include descriptions of when to provide input (e.g., depress) to a button of the audio device 104. For example, the prompt(s) 114 may indicate when to press and hold down the button. In some instances, the button in which the participant 106 provides input may be associated with a mute button, on/off button, etc. of the audio device 104. In some instances, the series of prompt(s) 114 may be displayed prior to, during, and/or after the participant 106 provides the input. For example, the endpoint 102 may display a countdown to inform the participant 106 of when to depress the button for pairing the audio device 104 with the endpoint 102. As the participant 106 provides the input, the display may also display how long, or for how much longer, the participant 106 is to provide the input.

The series of prompt(s) 114 as displayed by the endpoint 102 may be associated with a unique pattern or sequence of when the participant 106 is to press or release the button, as well as for how long the participant is to press and release the button. For example, the series of prompt(s) 114 may include hold down times that may range from one second, to a couple seconds, to several seconds. In some instances, the hold down times may be randomized and unique to the series of prompt(s) 114, the endpoint 102, and/or the audio device 104. During the series of prompt(s) 114, the display of the endpoint 102 may display a countdown (e.g., timer) to guide the participant 106 as to when to press and release the button. Any number of prompt(s) 114 may be output via the endpoint 102.

The audio device 104, in response to the input(s) at the button, generates input data 118 that indicates the series of input(s) provided to the button. The input data 118 may also be associated with when, and for how long, the button did not receive input(s). After providing the inputs, the audio device 104 may send the input data 118 to the endpoint 102 via the network(s) 108. Upon receipt of the input data 118, the endpoint 102 may compare the inputs provided at the audio device 104 to determine whether to pair with the audio device 104. For example, if the input data 118 indicates that the participant 106 pressed, released, etc. the button as instructed, and for the prompted periods of time, the endpoint 102 may determine that the inputs at the audio device 104 are similar to the series of prompt(s) 114. Accordingly, if the participant 106 performs the series of prompt(s) 114 as instructed, the audio device 104 and the endpoint 102 may be paired.

After pairing the audio device 104 and the endpoint 102, the audio device 104 may begin capturing audio, via the microphone(s), and may then send audio data 116 associated with the audio to the endpoint 102. That is, after pairing (or associating) the audio device 104 and the endpoint 102, the audio device 104 may capture audio associated with the conference, for example, and the endpoint 102, or another communicatively connected device on the network(s) 108 may distribute the audio data 116 to other participants 106 within the conference. The audio devices 104 may therefore act as an extension of the endpoint 102 for capturing audio.

In some instances, whether the audio device 104 is paired with the endpoint 102 using the ultrasonic signal(s) 112 and/or the series of prompt(s) 114 may be based at least in part on specifics of the endpoint 102 and/or the audio device 104. For example, the endpoint 102 may output the ultrasonic signal(s) 112 and/or the series of the prompt(s) 114 based at least in part on a manufacturer of the endpoint 102 and/or the audio device 104. In some instances, the endpoint 102 may determine whether a manufacturer of the endpoint 102 and the audio device 104 are similar, and if so, may pair the endpoint 102 and the audio device 104 using the ultrasonic signal(s) 112. Comparatively, if the manufacturer of the endpoint 102 and the audio device 104 are different, the endpoint 102 and the audio device 104 may be paired using the series of prompt(s) 114.

In some instances, to determine the manufacturer of the audio device 104, the endpoint 102 may output a prompt on the display. For example, the display may output an indication whether the audio device 104 is of a certain manufacturer. Using speech, touch input (e.g., button), or a remote control associated with the endpoint 102, the participant 106 may provide a corresponding response. As an alternative example, the endpoint 102 may determine security layers, configurations, or settings of the audio device 104 within the environment 100. In this example, a similar manufacture of the endpoint 102 and the audio device 104 may have like security layers, configurations, and/or settings, and such information may be used to deduce whether the manufacturers of the audio device 104 and the endpoint 102 are similar. Further, as another example, the endpoint 102 may discover device(s) within the environment 100, as a part of a discovery process, for obtaining information about a device type of the audio device 104. However, although described herein as using a manufacturer of the audio device 104 for determining whether to output the ultrasonic signal(s) 112 and/or the series of prompt(s) 114, other characteristics may be used. For example, whether the endpoint 102 outputs the ultrasonic signal(s) 112 and/or the series of the prompt(s) 114 may be based at least in part on a number of audio devices 104 to be paired with the endpoint 102, functionalities of the audio device 104 and/or the endpoint 102, and so forth.

The network(s) 108 may include any number of devices, including the endpoint 102 and the audio device 104. In some instances, to ensure that the audio data 116 and/or the input data 118 is routed correctly, such as to the endpoint 102, IP addresses, MAC addresses, device identifiers, etc. may be used. For example, as the network(s) 108 may have a plurality of devices, and to ensure that the data is routed to an intended device on the network(s) 108, IP addresses, MAC addresses, device identifiers, etc. may be used. In some instances, the IP addresses, MAC addresses, device identifiers, etc. may be embedded within the ultrasonic signal(s) 112 and the audio data 116. As the audio device 104 sends the audio data 116 to the endpoint 102, such information may be used to route the audio data to the endpoint 102. The audio data 116 may also include an IP address, MAC address, device identifier, etc. of the audio device 104. In other instances, the audio data 116 and/or the input data 118 may be routed to the endpoint 102 based on knowing that the endpoint 102 is in pairing mode. That is, as the endpoint 102 may be one of many endpoints on the network(s) 108, which that the endpoint 102 is in pairing mode may be used to deduce where the audio data 116 and/or the input data 118 should be routed.

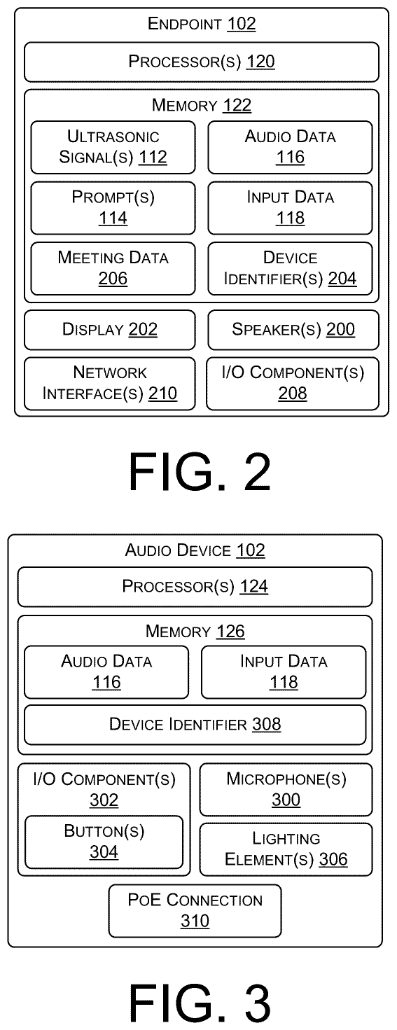

The endpoint 102 is shown including processor(s) 120 and memory 122, where the processor(s) 120 may perform various functions associated with outputting the ultrasonic signal(s) 112 and/or the series of prompt(s) 114, as well as comparing the ultrasonic signal(s) 112 with the audio data 116 and/or the series of prompt(s) 114 with the input data 118, respectively, and the memory 122 may store instructions executable by the processor(s) 120 to perform the operations described herein. Additional components of the endpoint 102 are discussed in FIG. 2.

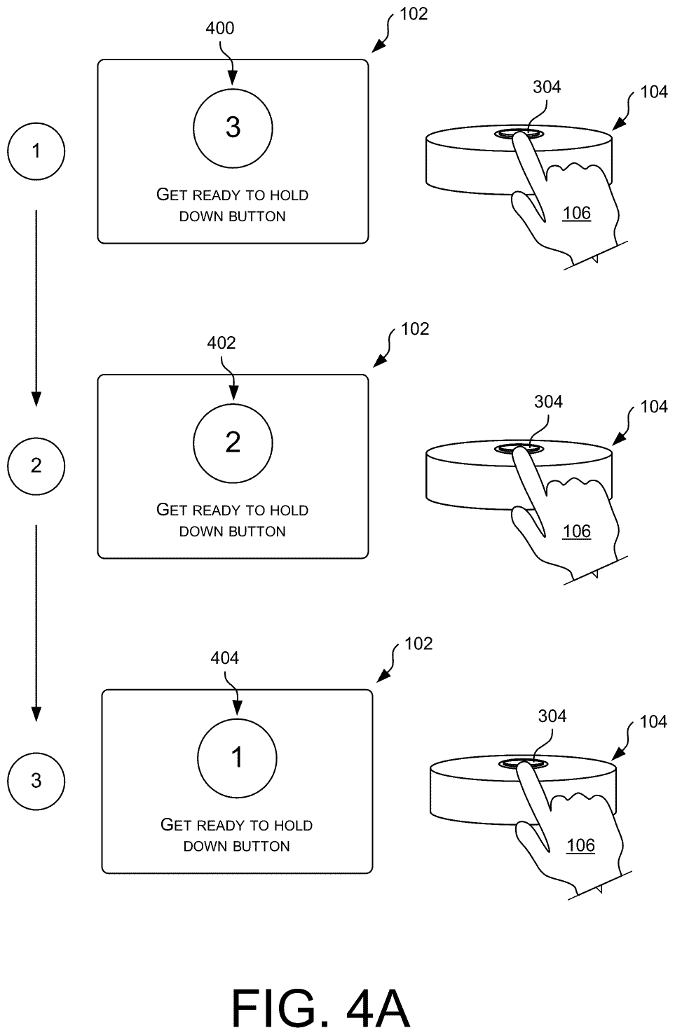

The audio device 104 is shown including processor(s) 124 and memory 126, where the processor(s) 124 may perform various functions associated with generating the audio data 116 and/or the input data 118, and the memory 126 may store instructions executable by the processor(s) 124 to perform the operations described herein. Additional components of the audio device 104 are discussed in FIG. 3.

In some instances, the network(s) 108 may be representative of any type of communication network, including data and/or voice network, and may be implemented using wired infrastructure (e.g., cable, CAT5, fiber optic cable, etc.), a wireless infrastructure (e.g., RF, cellular, microwave, satellite, Bluetooth, etc.), and/or other connection technologies.

Although the discussion in FIG. 1 is with regard to using the ultrasonic signal(s) 112 to pair the audio device 104 and the endpoint 102, in some instances, the endpoint 102 may output Bluetooth signals (or data) and/or UWB signals (or data) for pairing with the audio device 104. To receive the signals, the audio device 104 includes corresponding Bluetooth and/or UWB radios. Upon receipt of the signal from the endpoint 102, the audio device 104 may transmit a signal back to the endpoint 102 via the corresponding radio, or may transmit a signal back to the endpoint 102 via the network(s) 108. The signal received at the audio device 104 may include a device identifier of the endpoint 102, and the signal sent to the endpoint 102 may include a device identifier of the audio device 104. Using these two device identifiers, the endpoint 102 and the audio device 104 may be paired with one another.

FIG. 2 illustrates select components of the endpoint 102, according to examples of the present disclosure. As introduced above, the endpoint 102 includes the processor(s) 120 and the memory 122. The memory 122 is shown including the ultrasonic signal(s) 112, the audio data 116 received from the audio device 104, the prompt(s) 114, and the input data 118 received from the audio device 104.

Speaker(s) 200 of the endpoint 102 are configured to output the ultrasonic signal(s) 112. The ultrasonic signal(s) 112 may represent audible sound waves having a frequency of 20 kilohertz (kHz) or greater. At this frequency range, the ultrasonic signal(s) 112 are inaudible to humans (e.g., the participant(s) 106). The speaker(s) 200 may also output audio that is below 20 kHz, which is audible to humans. The endpoint 102 may include any number of the speaker(s) 200.

The prompt(s) 114 may include visual or audible prompt(s) output on a display 202 of the endpoint 102 and/or via the speaker(s) 200 of the endpoint 102. For example, as discussed above, the prompt(s) 114 may include instructions for the participants 106 to pair the audio device 104 and the endpoint 102. For example, the display 202 may present a series of the prompt(s) 114 associated with a sequence of button(s) to press on the audio device 104, a length of time by which to depress the button(s) on the audio device 104, and so forth. In some instances, the sequence of prompt(s) 114 may include hold down times that are randomized and unique. In some instances, the prompt(s) 114 may be specific to the endpoint 102 itself, and/or an operator of the endpoint 102 may select or otherwise define the prompt(s) 114. The display 202 may represent any suitable display, and in some instances, may be touch-sensitive.

In response to receiving the audio data 116 and/or the input data 118, the endpoint 102, such as the processor(s) 120, are configured to compare the audio data 116 and/or the input data 118 with the ultrasonic signal(s) 112 and the prompt(s) 114, respectively. For example, the processor(s) 120 may compare characteristic(s) of the ultrasonic signal(s) 112 (e.g., wavelength, pitch, amplitude, etc.) with characteristic(s) of the ultrasonic signal(s) 112 represented within the audio data 116. If the ultrasonic signal(s) 112 as emitted via the speaker(s) 200 are similar (e.g., greater than a threshold similarity) to the ultrasonic signal(s) 112 referenced within the audio data 116, the endpoint 102 may be paired with the audio device 104. Likewise, the processor(s) 120 may compare the input(s) provided to or at the audio device 104 with the inputs referenced with the prompt(s) 114. For example, characteristic(s) of the prompt(s) 114 (e.g., presses, releases, as well as the times associated therewith) may be compared with characteristic(s) of the inputs provided at the button of the audio device 104 (e.g., e.g., presses, releases, as well as the times associated therewith). If the input data 118 indicates that the input(s) at the audio device 104 match, or are similar to those within the prompt(s) 114 (e.g., greater than a threshold), the audio device 104 and the endpoint 102 may be paired.

The memory 122 is further shown having access to or storing device identifier(s) 204. In some instances, the device identifier(s) 204 may correspond to a device identifier of the endpoint 102, and/or device identifier(s) 204 of the audio device(s) 104. For example, the device identifier 204 of the endpoint 102 may be included within the ultrasonic signal(s) 112 as output to the audio device 104. The data that is send back to the endpoint 102, via the network(s) 108, and from the audio device 104, may include data associated with the device identifier 204 of the endpoint 102. In some instances, using the device identifier 204 of the endpoint 102 may be used to route the data to the endpoint 102. The device identifier(s) 204 of the audio device 104 may be used by the endpoint 102 for knowing those audio device(s) 104 that the endpoint is connected to.

The memory 122 may also have access to meeting data 206. In some instances, the meeting data 206 may be associated with a meeting taking place at least partially using the endpoint 102. In some instances, the endpoint 102 may be hosting the meeting, or the endpoint 102 may communicatively connect, via the network(s) 108, with another device hosting the meeting. In some instances, the meeting data 206 may include a time, place, and/or location of the meeting, an identifier of the meeting, the participant(s) 106 in the meeting, content presented (e.g., shared) during the meeting, and well as audio captured during the meeting. In some instances, the meeting data 206 may also include a transcript of the meeting.

The endpoint 102 may also include additional input/output (I/O) components 208. The I/O components 208 may include keyboards, touch-sensitive interfaces, button(s), microphone(s), and so forth. For example, microphone(s) of the endpoint 102 may additionally or alternatively generate audio data 116 associated with speech of the participant(s) 106 in the environment 100, and/or audio data 116 for output on the speaker(s) 200. The endpoint 102 may also include network interface(s) 210 (e.g., Bluetooth, UWB, Wi-Fi radios, transceivers, etc.) for communicatively connecting to the network(s) 108. In some instances, the endpoint 102 may connect to the network(s) 108 via wired and/or wired connections.

FIG. 3 illustrates select components of the audio device 104, according to examples of the present disclosure. As introduced above, the audio device 104 includes the memory 126 that stores or has access to the audio data 116 and/or the input data 118. The audio data 116 may be generated in response to microphone(s) 300 capturing audio. The microphone(s) 300 are configured to generate the audio data 116 in response to the ultrasonic signal(s) 112 (e.g., at or above 20 kHz), as well as in response to speech from the participants 106 and/or other sounds in the environment (e.g., below 20 kHz). The audio device 104 may include any number of the microphone(s) 300. The microphone(s) 300 may therefore capture audio that is audible and inaudible to the participants 106.

The audio device 104 may also include input/output (I/O) components 302, such as button(s) 304. In some instances, the audio device 104 may include any number of the button(s) 304 that are associated with at least partially controlling an operation of the audio device 104 (e.g., mute, volume up, volume down, pair, etc.). The button(s) 304 may be configured to generate the input data 118 in response to presses of the button(s) 304. The input data 118 may also indicate periods of time that the button(s) 304 are not depressed (e.g., when the button(s) 304 are released). The button(s) 304 may include capacitive-type button(s), resistive-type button(s), mechanical-type button(s), and so forth. Additional or alternative I/O component(s) 302 include keyboards, touch-interfaces, switches, levers, etc.

The audio device 104 may also include lighting element(s) 306. In some instances, the lighting element(s) 306 may illuminate to different colors, patterns, sequences, and so forth. The lighting element(s) 306 may include LEDs, OLEDs, etc. In some instances, the lighting element(s) 306 are disposed around or at least partially encircle the button(s) 304. The lighting element(s) 306 may illuminate based at least in part on operation(s) being performed by the audio device 104, such as whether the audio device 104 is capturing audio, whether the audio device is on/off, whether the audio device 104 is on mute, whether the audio device 104 is pairing with the endpoint 102, and so forth.

The audio device 104 is further shown storing or having access to device identifier(s) 308. In some instances, the device identifier(s) 308 may correspond to a device identifier of the endpoint 102, and/or a device identifier of the audio device 104. For example, the device identifier 204 of the endpoint 102 may be included within the ultrasonic signal(s) 112, and the audio device 104 may store the device identifier of the endpoint 102. The data that is send back to the endpoint 102, via the network(s) 108, and from the audio device 104, may include data associated with the device identifier of the endpoint 102. In some instances, using the device identifier of the endpoint 102 may be used to route the data to the endpoint 102. The audio device 104 may also send the device identifier of the audio device 104 for use by the endpoint 102 to understand those audio device(s) 104 that the endpoint 102 is connected to.

The audio device 104 may include a PoE connection 310 (e.g., port) for powering components of the audio device 104 and connecting the audio device 104 to the network(s) 108 in order to send and receive data to devices on the network(s) 108. For example, the audio device 104 may couple to the network(s) 108 via an Ethernet port disposed within the environment 100. Through the PoE connection 310, the audio device 104 may transmit the audio data 116 and the input data 118 over the network(s) 108.

In some instances, the audio device 104 may be considered a headless device having limited functionality. In some instances, the audio device 104 may not include radio(s), transceiver(s), etc. for communicating with other devices. In some instances, the audio device 104 may be considered an AoIP microphone. However, in some instances, the audio device 104 may have increased functionalities and include Bluetooth radios, UWB radios, etc. for receiving Bluetooth signals, UWB signals, etc. from the endpoint 102 for pairing purposes.

As used herein, a processor, such as the processor(s) 120 and/or the processor(s) 124, may include multiple processors and/or a processor having multiple cores. Further, the processor(s) may comprise one or more cores of different types. For example, the processor(s) may include application processor units, graphic processing units, and so forth. In one implementation, the processor(s) may comprise a microcontroller and/or a microprocessor. The processor(s) may include a graphics processing unit (GPU), a microprocessor, a digital signal processor or other processing units or components known in the art. Alternatively, or in addition, the functionally described herein may be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program components, program data, and/or one or more operating systems.

Memory, such as the memory 122 and/or the memory 126, may include volatile and nonvolatile memory, removable and non-removable media implemented in any method or technology for storage of information, such as computer-readable instructions, data structures, program component, or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which may be used to store the desired information and which may be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which may be used to store the desired information and which may be accessed by the processor(s). In some instances, the memory 122 and/or the memory 126 may represent one or more non-transitory computer-readable media storing instructions that, when executed by the processor(s) 120 and the processor(s) 124, respectively, cause the processor(s) 120 and the processor(s) 124 to perform recited operations.

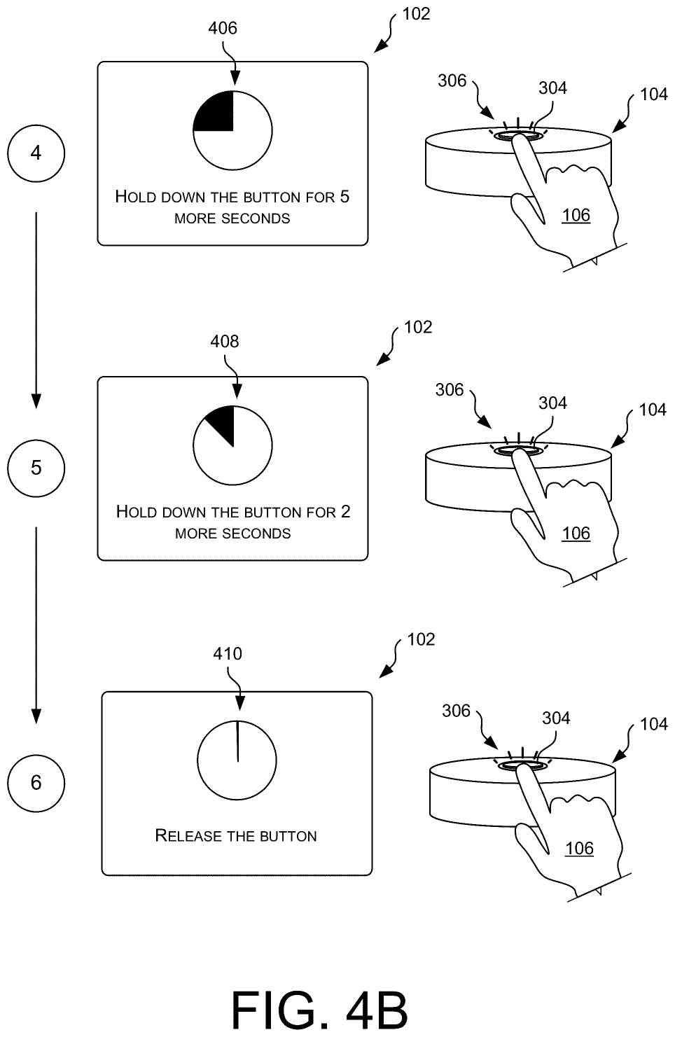

FIGS. 4A and 4B illustrate an example sequence in which the endpoint 102 outputs a series of prompt(s) 114 to pair the endpoint 102 with the audio device 104, according to examples of the present disclosure.

At “1” in FIG. 4A, the endpoint 102 is shown displaying a first prompt associated with a countdown before the participant 106 is prompted to press the button 304. For example, at “1,” the endpoint 102 may output a prompt that indicates to hold down the button 304 in 3 seconds. An indication 400 may be displayed to indicate to hold down the button 304 for 3 seconds. At “2” in FIG. 4A, the endpoint 102 may display a second prompt associated with the countdown. For example, at “2,” the endpoint 102 may indicate to hold down the button 304 in 2 seconds. An indication 402 may be displayed to indicate to hold down the button 304 for 2 seconds. At “3” in FIG. 4A, the endpoint 102 may display a third prompt associated with the countdown. For example, at “3,” the endpoint 102 may indicate to hold down the button 304 for 1 second. An indication 404 may be displayed to indicate to hold down the button 304 for 3 seconds. Accordingly, from “1”-“3”, the participant 106 may not depress the button 304. Instead, the endpoint 102 may output a series of prompt(s) 114 associated with a countdown before the participant 106 is instructed to hold down the button 304.

At “4” in FIG. 4B, the endpoint 102 may display a fourth prompt associated with holding down the button 304, as well as an indication 406 of a timer (or countdown) to remain holding down the button 304. For example, the fourth prompt may indicate to hold down the button 304 for 5 seconds, and the indication 406 may indicate a remaining amount of time (e.g., 5 seconds) to hold down the button 304. In some instances, as the participant 106 presses the button 304, the lighting element(s) 306 may illuminate to a certain color, pattern, intensity, etc.

At “5” in FIG. 4B, the endpoint 102 may display a fifth prompt associated with holding down the button 304, as well as an indication 408 of the timer to remain holding down the button 304. For example, the fifth prompt may indicate to hold down the button 304 for 2 seconds, and the indication 408 may indicate a remaining amount of time (e.g., 2 seconds) to hold down the button 304. Here, the endpoint 102 may be updated to indicate the amount of time remaining to hold down the button 304. In other words, the indication 408 of the timer may be updated as the participant 106 presses the button 304. In some instances, as the participant 106 presses the button 304, the lighting element(s) 306 may illuminate.

At “6” in FIG. 4B, the endpoint 102 may display a sixth prompt associated with releasing the button 304, as well as an indication 410 of the timer to release the button 304. For example, the sixth prompt may indicate to release the button 304, and the indication 410 may indicate that no time remains for holding down the button 304. As such, the endpoint 102 may be updated to indicate the amount of time remaining to hold down the button 304. In other words, the indication 410 of the timer may be expired (e.g., after 5 seconds), and indicate to the participant 106 to release the button 304. In some instances, as the participant 106 releases the button 304, the lighting element(s) 306 may illuminate to a different color, intensity, pattern, etc. than when the participant 106 pressed the button 304.

Accordingly, from “4”-“6” the endpoint 102 may output the series of prompt(s) 114 associated with the participant 106 pressing and releasing the button 304. The indications (e.g., 400-410), for example, may be updated to indicate an amount of time remaining to hold down the button 304, or for how much longer the participant 106 is to hold down the button 304, when to participant 106 is to press the button 304, etc. Such prompt(s) 114 may guide the participant 106 in order to pair the audio device 104 with the endpoint 102.

Although FIGS. 4A and 4B illustrate a specific scenario in which the endpoint 102 outputs the series of prompt(s) 114, other scenarios are envisioned. For example, more or less prompt(s) 114 may be output by the endpoint 102. As an example, after pressing the button 304 for 5 seconds, and then releasing the button 304, the prompt(s) 114 may prompt the participant 106 to hold down the button 304 for 3 seconds. During this sequence, the endpoint 102 may output respective prompt(s) 114. Any number of prompt(s) 114 to press and release the button 304 may be used, and the amounts of time to press and release the button 304 may be varied (e.g., from a second, a couple seconds, several seconds, etc.). Regardless, after pressing and releasing the button 304, the audio device 104 may generate input data 118 indicative of the input(s) to the button 304. That is, the input data 118 may indicate when the button 304 was pressed, released, etc., as well as the amount of times in which the button 304 was pressed, released, etc. The input data 118 is sent to the endpoint 102, via the network(s) 108, and upon receipt, the endpoint 102 may determine whether the input(s) provided to the button 304 correspond to the prompt(s) 114. Through this comparison, the endpoint 102 may determine whether to pair with the audio device 104.

In some instances, the button 304 is located on a top of the audio device 104, however, other variations are envisioned. For example, the button 304 may be located on other sides, surfaces, etc. Moreover, rather than including the button 304, the audio device 104 may include toggles, knobs, switches, etc. associated with providing the input. Additionally, the lighting element(s) 306 is shown encircling the button 304, however, the lighting element(s) 306 may be disposed differently on or about the audio device 104.

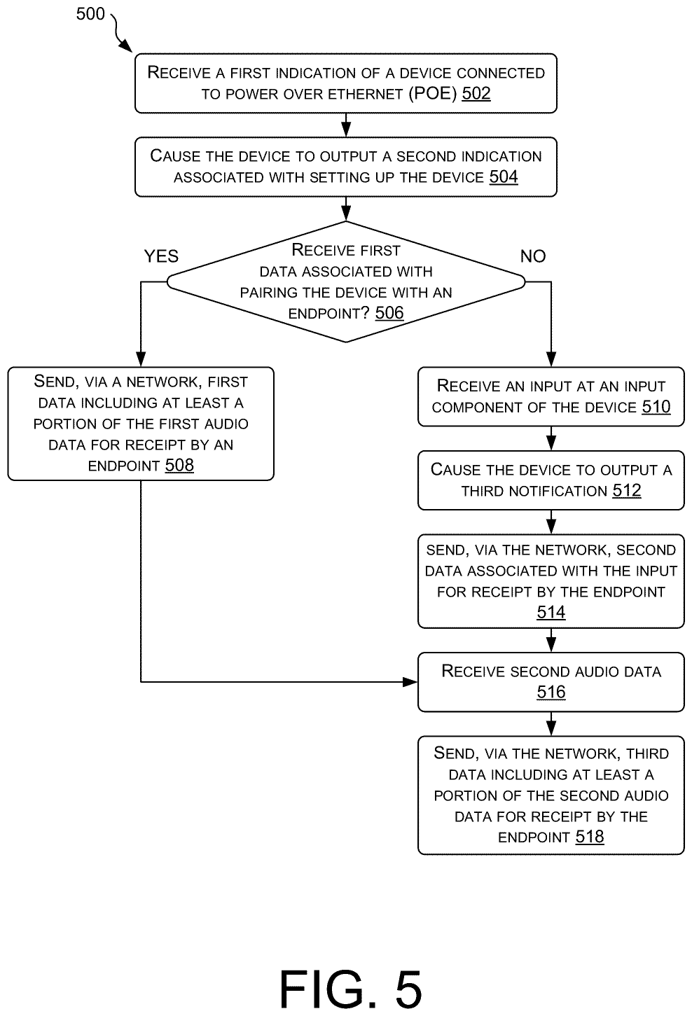

FIGS. 5-8 illustrates example processes for pairing devices, such as the endpoint 102 and the audio device 104. The processes described herein is illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures, devices, and systems described in the examples herein, such as, for example those described with respect to FIGS. 1-4B, although the processes may be implemented in a wide variety of other environments, architectures, devices, and systems.

FIG. 5 illustrates an example process 500 associated with pairing the audio device 104 within the endpoint 102, according to examples of the present disclosure. In some instances, the process 500 may be performed by the audio device 104.

At 502, the process 500 may include receiving a first indication of a device connected to power over ethernet (POE). For example, the audio device 104 may be plugged into an Ethernet port within the environment 100 using an Ethernet cable. The audio device 104 includes the PoE connection 310 for connecting to the Ethernet port. The PoE connection 310 provides the audio device 104 with power, as well as connects the audio device 104 to the network(s) 108. Upon being connected to the Ethernet port in the environment 100, or having the PoE connection 310, the processor(s) 120 of the audio device 104 may receive an indication of such (e.g., via power being received).

At 504, the process 500 may include causing the device to output a second indication associated with setting up the device. For example, upon being plugged into the Ethernet port, receiving power, and/or connecting to the network(s) 108, the audio device 104 may cause the lighting element(s) 306 to illuminate to a certain appearance state (e.g., color, intensity, pattern, etc.). In some instances, the lighting element(s) 306 illuminate to the certain appearance state to indicate that the audio device 104 is in setup mode. In setup mode, the audio device 104 may be ready, or permitted, to pair with the endpoint 102. For example, the audio device 104 may expect to receive the ultrasonic signal(s) 112 and/or presses of the button 304.

At 506, the process 500 may include determining whether the device received first audio associated with pairing the audio device with an endpoint. For example, in instances in which the endpoint 102 and the audio device 104 are paired using the ultrasonic signal(s) 112, the audio device 104 may receive audio associated with the ultrasonic signal(s) 112. Otherwise, the audio device 104 may receive indications of input(s) at the button 304. The audio device 104 may therefore await the ultrasonic signal(s) 112 or the input(s) at the button 304 to know how to pair with the endpoint 102. If at 506, the process 500 determines that the first audio was received, the process 500 may follow the “YES” route and proceed to 508. For example, the endpoint 102 may have output the ultrasonic signal(s) 112, and the microphone(s) 300 of the audio device 104 may have captured audio associated with the ultrasonic signal(s) 112. In some instances, in setup mode, the audio device 104 may await receipt of audio that is inaudible to the participants 106 (e.g., the ultrasonic signal(s) 112).

At 508, the process 500 may include sending, via a network, first data including at least a portion of the first audio data for receipt by the endpoint. For example, upon receiving the ultrasonic signal(s) 112, the audio device 104 may generate the audio data 116. The audio data 116, or more generally, data, may then be sent via the network(s) 108 to the endpoint 102. In some instances, the data may include a device identifier, IP address, MAC address, etc. of the endpoint 102. Such information may be used to route the data to the endpoint 102, as compared to other device(s), server(s), etc. on the network(s) 108. In some instances, the device identifier, IP address, MAC address, etc. of the endpoint 102 may be embedded within the ultrasonic signal(s) 112 and received via the audio device 104. Additionally, or alternatively, the data sent to the endpoint 102 may include a device identifier, IP address, MAC address, etc. of the audio device 104, which enables the endpoint 102 to identify the audio device 104 being paired.

Upon receipt of the data, the endpoint 102 may compare the audio data 116 representative of the ultrasonic signal(s) 112 with the ultrasonic signal(s) 112 output by the speaker(s) 200 of the endpoint 102. If the audio data 116 and the ultrasonic signal(s) 112 are similar, the audio device 104 and the endpoint 102 may be paired. In some instances, after being paired, the audio device 104 may output an indication of such (e.g., lighting element(s) 306 may illuminate) to indicate to the participant 106 that the endpoint 102 and the audio device 104 have been paired.

Returning to 506, if at 506 the process 500 determines that the first audio was not received, the process 500 may follow the “NO” route and proceed to 510. At 510, the process 500 may include receiving an input at an input component of the device. For example, the button 304 of the audio device 104 may receive input associated with the participant 106 pressing the button 304. In such instances, input(s) at the button 304 may be used to pair the audio device 104 and endpoint 102, as compared to using the ultrasonic signal(s) 112.

At 512, the process 500 may include causing the device to output a third indication. For example, in response to receiving the input at the button 304, the lighting element(s) 306 of the audio device 104 may illuminate to a certain appearance state. In some instances, the lighting element(s) 306 may illuminate to different appearance states as the input(s) are provided to the button 304. For example, although the process 500 is described as receiving an input, any number of input(s) may be provided to the button 304 (e.g., a series of press(es) and release(s)). During this sequence, the lighting element(s) 306 may turn on and off, or output certain appearance states, to visually indicate the input(s) at the button 304.

At 514, the process 500 may include sending, via the network, second data associated with the input for receipt by the endpoint. For example, upon receiving the input, or after the input(s) are received, the audio device 104 may generate the input data 118. In some instances, the audio device 104 may generate and send the input data 118 after a threshold period of time has elapsed since receiving a last input. This may ensure that all inputs at the button 304 may been received before sending the input data 118 to the endpoint 102. In other instances, the input data 118 may be sent continuously as the input(s) are provided to the button 304. In some instances, the data may include a device identifier, IP address, MAC address, etc. of the endpoint 102. Such information may be used to route the data to the endpoint 102, as compared to other device(s), server(s), etc. on the network(s) 108. Additionally, or alternatively, the data sent to the endpoint 102 may include a device identifier, IP address, MAC address, etc. of the audio device 104, which enables the endpoint 102 to identify the audio device 104 being paired.

At 516, the process 500 may include receiving second audio data. For example, once the audio device 104 and the endpoint 102 are paired, the audio device 104 may begin capturing audio data 116, which may in turn, be sent to the endpoint 102. The audio device 104 may continuously generate the audio data 116 throughout the meeting. The process 500 may also proceed to 516 following 508. In some instances, the audio device 104 may receive an indication or acknowledgement that it has been paired with the endpoint 102.

At 518, the process 500 may include sending, via the network, third data including at least a portion of the second audio data for receipt by the endpoint. For example, as the microphone(s) 300 of the audio device 104 capture audio within the environment 100, the audio device 104 may generate the audio data 116 and second the audio data 116 to the endpoint 102.

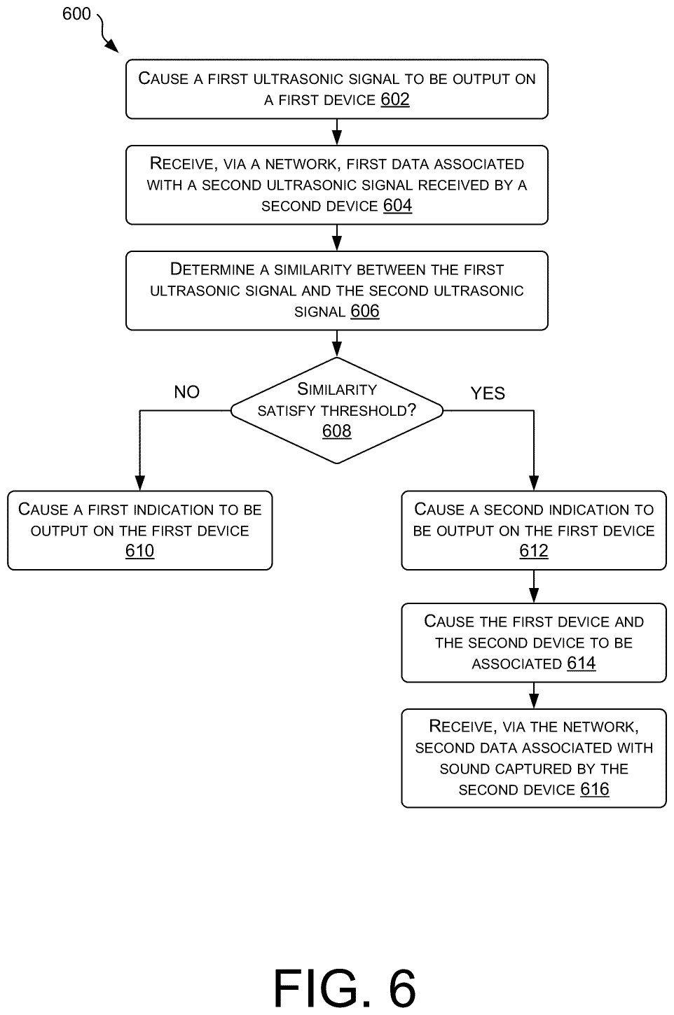

FIG. 6 illustrates an example process 600 associated with pairing the endpoint 102 and the audio device 104 using the ultrasonic signal(s) 112, according to examples of the present disclosure. In some instances, the process 600 may be performed by the endpoint 102.

At 602, the process 600 may include causing a first ultrasonic signal to be output on a first device. For example, the endpoint 102, using the speaker(s) 200, may output the ultrasonic signal 112. In some instances, the ultrasonic signal 112 may be output in response to input(s) provided at, or to, the endpoint 102. For example, the participant 106 in the environment 100 may select to cause the ultrasonic signal 112 to be output, as compared to the series of prompt(s) 114. In some instances, the ultrasonic signal 112 may be embedded with (e.g., contain metadata) associated with a device identifier, IP address, MAC address, etc. of the endpoint 102. In some instances, the endpoint 102 may output a single or multiple ultrasonic signal(s) 112.

At 604, the process 600 may include receiving, via a network, first data associated with a second ultrasonic signal as received by a second device. For example, the endpoint 102 may receive, via the network(s) 108, the audio data 116 (or data) indicative of the first ultrasonic signal as output by the endpoint 102. The second ultrasonic signal, however, may be associated the ultrasonic signal 112 as received by the audio device 104. In some instances, the endpoint 102 may receive the audio data 116 based at least in part on outputting the ultrasonic signal 112 and/or being in pairing mode. For example, as the network(s) 108 may contain a plurality of device(s), to route the audio data 116 to the appropriate device on the network(s) 108, knowing which endpoints 102 are outputting the ultrasonic signal(s) 112 and/or in pairing mode may be used to deduce where to route the audio data 116.

At 606, the process 600 may include determining a similarity between the first ultrasonic signal and the second ultrasonic signal. For example, the endpoint 102 may compare the ultrasonic signal 112 output by the endpoint 102, with the ultrasonic signal 112 as received by the audio device 104. In other words, the first ultrasonic signal may represent an ultrasonic signal output by the endpoint 102, while the second ultrasonic signal may represent an ultrasonic signal as received by the endpoint 102 (and as represented within the audio data 116). In some instances, the similarity may include determining pitches, wavelengths, amplitudes, etc. of the first ultrasonic signal and the second ultrasonic signal. In other instances, the similarity may be associated with metadata that is embedded or included within the ultrasonic signal 112, and the endpoint 102 may compare the metadata as embedded within the ultrasonic signal 112 with the data provided back to the endpoint 102 from the audio device 104.

At 608, the process 600 may include determining whether the similarity satisfies a threshold. For example, the endpoint 102 may determine whether the similarity satisfies a threshold before pairing the endpoint 102 and the audio device 104. As such, in instances in which the ultrasonic signal 112 as captured by the audio device 104 is dissimilar to the ultrasonic signal 112 as output by the endpoint 102, the endpoint 102 and the audio device 104 may not be paired. Conversely, in instances in which the ultrasonic signal 112 as captured by the audio device 104 is similar to the ultrasonic signal 112 as output by the endpoint 102, the endpoint 102 and the audio device 104 may be paired. In some instances, the threshold to which the similarity is compared may be based on specifics of the endpoint 102, the audio device 104, the environment 100, etc. If at 608 the process 600 determines that the similarity is not greater than the threshold, the process 600 may follow the “NO” route and proceed to 610.

At 610, the process 600 may include causing a first indication to be output on the first device. For example, when the similarity is not greater than the threshold, the endpoint 102 may output an indication that the endpoint 102 and the audio device 104 have not been paired (or have unsuccessfully been paired). In some instances, the indication may be output via the display 202 and/or the speaker(s) 200 of the endpoint 102. Moreover, in some instances, when the endpoint 102 and the audio device 104 fail to be paired using the ultrasonic signal(s) 112, the endpoint 102 and the audio device 104 may attempt to be paired using the series of the prompt(s) 114.

Returning to 608, if the process 600 determines that the similarity is greater than the threshold, the process 600 may follow the “YES” route and proceed to 612. At 612, the process 600 may include causing a second indication to be output on the first device. For example, when the similarity satisfies the threshold, the endpoint 102 may output an indication that the endpoint 102 and the audio device 104 have been paired. In some instances, the indication may be output via the display 202 and/or the speaker(s) 200 of the endpoint 102.

At 614, the process 600 may include causing the first device and the second device to be associated. For example, based at least in part on the endpoint 102 and the audio device 104 being paired, the endpoint 102 and the audio device 104 may be associated with one another. The association of the endpoint 102 and the audio device 104 may be used to associated audio data 116 generated via the audio device 104 with the conference being held on the endpoint 102. Moreover, the association between the endpoint 102 and the audio device 104 may be used to route the audio data 116 from the audio device 104 to the endpoint 102.

At 616, the process 600 may include receiving, via the network, second data associated with sound captured by the second device. For example, once the audio device 104 and the endpoint 102 are paired, the audio device 104 may begin capturing audio data 116, which may in turn, be sent to the endpoint 102. The audio device 104 may continuously generate the audio data 116 throughout the meeting for sending to the endpoint 102. Here, the audio data 116 may be associated with speech of the participants 106 captured during the meeting.

Although the process 600 illustrates pairing the endpoint 102 with a single audio device 104, the endpoint 102 may be paired with other audio devices 104. In such instances, the same ultrasonic signal(s) 112 or different ultrasonic signal(s) 112 may be output on the endpoint 102. Further, some of the audio devices 104 may be paired using the ultrasonic signal(s) 112, while some of the audio devices 104 may be paired using the series of prompt(s) 114.

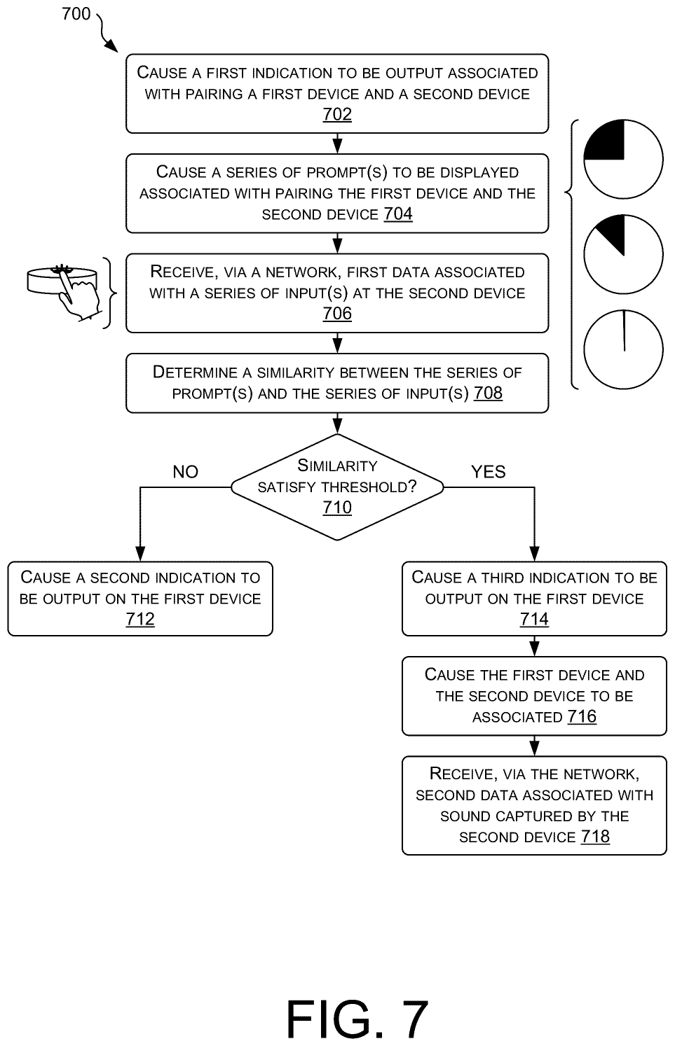

FIG. 7 illustrates an example process 700 associated with pairing the endpoint 102 and the audio device 104 using the series of prompt(s) 114, according to examples of the present disclosure. In some instances, the process 700 may be performed by the endpoint 102.

At 702, the process 700 may include causing a first indication to be output associated with paring a first device and a second device. For example, the endpoint 102 may output, via the display 202 and/or the speaker(s) 200, an indication associated with pairing the endpoint 102 and the audio device 104. In some instances, the first indication may be associated with a countdown as to when the participant 106 is to hold down the button 304.

At 704, the process 700 may include causing a series of prompt(s) to be displayed associated with pairing the first device and the second device. For example, using the display 202, the endpoint 102 may output the series of prompt(s) 114. In some instances, the series of prompt(s) 114 may indicate when to depress the button 304, when to release the button 304, as well as times (e.g., an amount of time) to depress and release the button 304. The series of prompt(s) 114 may be updated in real time to visually indicate when to press and release the button 304, as well as the amount of time associate therewith. In some instances, any number of the prompt(s) 114 may be used, and the time(s) associated with the prompt(s) 114 to press and release the button 304 may be varied. In some instances, the amount of the prompt(s) 114 and/or the times associated therewith, may be based at least in part on the endpoint 102, the environment 100, the network(s) 108 (e.g., the amount of endpoints 102 pairing with audio devices 104), and/or may be user-defined (e.g., by the participant 106).

At 706, the process 700 may include receiving, via a network, first data associated with a series of inputs at the second device. For example, the endpoint 102 may receive, via the network(s) 108, data (e.g., the input data 118) associated with input(s) to the button 304. The data may indicate when the participant 106 pressed and released the button 304, as well as the amount of time the participant 106 pressed and released the button 304. In some instances, the data may be received after the input(s) have been provided, and/or as the input(s) are provided (e.g., in real time). In some instances, the first data may also include a device identifier of the audio device 104, an IP address of the audio device 104, a MAC address of the audio device 104, and so forth.

At 708, the process 700 may include determining a similarity between the series of prompt(s) and the series of input(s). For example, the endpoint 102 may compare the series of prompt(s) 114, or data associated therewith, with the series of input(s) provided to the button 304 (e.g., the input data 118). For example, if the prompt(s) 114 indicated to press the button 304 for five seconds, and then release the button 304, these prompt(s) 114 may be compared against the input data 118 to determine whether the participant 106 pressed the button 304 for five seconds and then released the button 304. As such, the endpoint 102 may more generally determine whether the participant 106 performed the prompt(s) 114 as output on the endpoint 102.

At 710, the process 700 may include determining whether the similarity satisfies a threshold. For example, the endpoint 102 may determine whether the similarity satisfies a threshold before pairing the endpoint 102 and the audio device 104. As such, in instances in which the input(s) at the audio device 104 are dissimilar to the prompt(s) 114 output by the endpoint 102, the endpoint 102 and the audio device 104 may not be paired. Conversely, in instances in which the input(s) at the audio device 104 are similar to the prompt(s) 114 as output by the endpoint 102, the endpoint 102 and the audio device 104 may be paired. In some instances, the threshold to which the similarity is compared may be based on specifics of the endpoint 102, the audio device 104, the environment 100, etc. For example, the threshold may indicate whether the prompt(s) 114 and the input(s) are 90%, 80%, etc. similar. In some instances, for example, if the prompt(s) 114 indicate to hold down the button for 5 seconds, and the input data 118 indicates that the button 304 was held down for 4.9 seconds, the similarity may satisfy the threshold. If at 710 the process 700 determines that the similarity is not greater than the threshold, the process 700 may follow the “NO” route and proceed to 712.

At 712, the process 700 may include causing a second indication to be output on the first device. For example, when the similarity is not greater than the threshold, the endpoint 102 may output an indication that the endpoint 102 and the audio device 104 have not been paired (or have unsuccessfully been paired). In some instances, the indication may be output via the display 202 and/or the speaker(s) 200 of the endpoint 102.

Returning to 710, if the process 700 determines that the similarity is greater than the threshold, the process 700 may follow the “YES” route and proceed to 714. At 714, the process 700 may include causing a third indication to be output on the first device. For example, when the similarity is greater than the threshold, the endpoint 102 may output an indication that the endpoint 102 and the audio device 104 have been paired. In some instances, the indication may be output via the display 202 and/or the speaker(s) 200 of the endpoint 102.

At 716, the process 700 may include causing the first device and the second device to be associated. For example, based at least in part on the endpoint 102 and the audio device 104 being paired, the endpoint 102 and the audio device 104 may be associated with one another. The association of the endpoint 102 and the audio device 104 may be used to associated audio data 116 generated via the audio device 104 with the conference being held on the endpoint 102. Moreover, the association between the endpoint 102 and the audio device 104 may be used to route the audio data 116 from the audio device 104 to the endpoint 102.

At 718, the process 700 may include receiving, via the network, second data associated with sound captured by the second device. For example, once the audio device 104 and the endpoint 102 are paired, the audio device 104 may begin capturing audio data 116, which may in turn, be sent to the endpoint 102. The audio device 104 may continuously generate the audio data 116 throughout the meeting for sending to the endpoint 102.

Although the process 700 illustrates pairing the endpoint 102 with a single audio device 104, the endpoint 102 may be paired with other audio devices 104. In such instances, the same series of prompt(s) 114 or a different series of prompt(s) 114 may be output on the endpoint 102. Further, some of the audio devices 104 may be paired using the ultrasonic signal(s) 112, while some of the audio devices 104 may be paired using the series of prompt(s) 114.

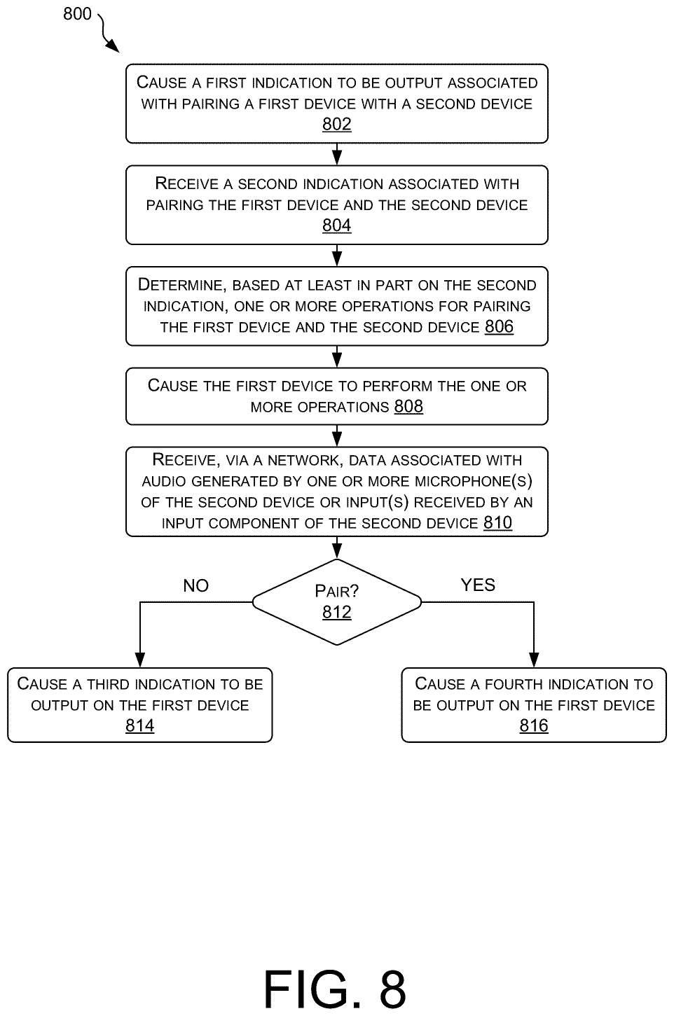

FIG. 8 illustrates an example process 800 associated with pairing the endpoint 102 and the audio device 104, according to examples of the present disclosure. In some instances, the process 800 may be performed by the endpoint 102.

At 802, the process 800 may include causing a first indication to be output associated with pairing a first device with a second device. For example, the endpoint 102 may output, on the display 202, an indication for pairing the endpoint 102 with audio device(s) 104 in the environment 100. In some instances, the indication as output may be associated with how to pair the endpoint 102 and the audio device(s) 104. For example, the indication may allow the participant to pair the endpoint 102 with the audio device 104 using the ultrasonic signals 112 and/or the prompt(s) 114. In some instances, the participant 106 may select the method of pairing the endpoint 102 and the audio device 104 via drop down menu(s), providing inputs to icon(s) on the display 202, and so forth. In other instances, the participant 106 may provide audio (e.g., speech) to select the method of pairing the endpoint 102 with the audio device 104.

At 804, the process 800 may include receiving a second indication associated with pairing the first device and the second device. For example, the participant 106 may provide input to the endpoint 102 as to the method of pairing the endpoint 102 and the audio device 104. Although described as receiving an input, for example, from the participant 106, the endpoint 102 may determine how to pair with the audio device 104. In such instances, the endpoint 102 may determine whether a manufacturer of the endpoint 102 and the audio device 104 are similar, and if so, may pair the endpoint 102 and the audio device 104 using the ultrasonic signals 112. Comparatively, if the manufacturer of the endpoint 102 and the audio device 104 are different, the endpoint 102 and the audio device 104 may be paired using the series of prompt(s) 114.

In some instances, to determine the manufacturer of the audio device 104, the endpoint 102 may output a prompt (e.g., at 802) on the display 202. For example, the display 202 may output an indication whether the audio device 104 is of a certain manufacturer. As an alternative example, the endpoint 102 may determine security layers, configurations, or settings of the audio device 104 as similar manufactures may have like security layers, configurations, and/or settings, and such information may be used to deduce whether the manufacturers of the audio device 104 and the endpoint 102 are similar. Further, as another example, the endpoint 102 may discover device(s) (including the audio device 104) within the environment 100, as a part of a discovery process, for obtaining information about a device type of the audio devices 104. Using the device type, the endpoint 102 may determine the manufacturer of the audio device. However, although described herein as using a manufacturer of the audio device 104 for determining whether to output the ultrasonic signals 112 and/or the series of prompt(s) 114, other characteristics may be used. For example, whether the endpoint 102 outputs the ultrasonic signal(s) 112 and/or the series of the prompt(s) 114 may be based at least in part on a number of audio devices 104 to be paired with the endpoint 102, functionalities of the audio device 104 and/or the endpoint 102, and so forth.

At 806, the process 800 may include determining, based at least in part on the second indication, one or more operations for pairing the first device and the second device. For example, the endpoint 102 may determine whether to pair the endpoint 102 and the audio device 104 using the ultrasonic signal(s) 112 or the series of prompt(s) 114. In some instances, based at least in part on determining how to pair the endpoint 102 and the audio device 104, the endpoint 102 may determine (or generate) the ultrasonic signal(s) 112 and/or the series of prompt(s) 114 to output. For example, the endpoint 102 may generate the prompt(s) 114 to indicate the amount of time to press and release the button 304.

At 808, the process 800 may include causing the first device to perform the one or more operations. For example, the speaker(s) 200 of the endpoint 102 may output the ultrasonic signal(s) 112, or the display 202 of the endpoint 102 may output the series of prompt(s) 114.

At 810, the process 800 may include receiving, via a network, data associated with audio generated via one or more microphone(s) of the second device or input(s) received by an input component of the second device. For example, depending upon the one or more operation(s) performed, such as how to pair the endpoint 102 with the audio device 104, the endpoint 102 may receive the audio data 116 or the input data 118 from the audio device 104. Regardless, the audio data 116 and the input data 118 may be received via the network(s) 108. In the case of the audio data 116, the audio data 116 may be associated with the ultrasonic signal(s) 112. In the case of input data 118, the input data 118 may be associated with presses of the button 304 (e.g., when and for how long the button 304 was pressed).

At 812, the process 800 may include determining whether to pair the first device and the second device. For example, the endpoint 102 may compare the audio data 116 as received from the audio device 104 to determine whether the audio is similar to, or represents, the ultrasonic signal(s) 112 as output by the endpoint 102. Alternatively, the endpoint 102 may compare the input data 118 as received from the audio device 104 to determine whether the input(s) at the button 304 are similar to, or represent, the prompt(s) 114 as output by the endpoint 102. In some instances, the endpoint 102 may be paired with the audio device 104 based on the audio data 116 and the ultrasonic signal(s) 112 having a threshold similarity, and/or the input data 118 and the prompt(s) 114 having a threshold similarity. If at 812 the process 800 determines to not pair the endpoint 102 and the audio device 104, the process 800 may follow the “NO” route and proceed to 814.

At 814, the process 800 may include causing a third indication to be output on the first device. For example, when the endpoint 102 and the audio device 104 are not paired, the endpoint 102 may output an indication that the endpoint 102 and the audio device 104 have not been paired (or have unsuccessfully been paired). In some instances, the indication may be output via the display 202 and/or the speaker(s) 200 of the endpoint 102.

Alternatively, if at 812 the process 800 determines to pair the first device and the second device, the process 800 may follow the “YES” route and proceed to 816. At 816, the process 800 may include causing a fourth indication to be output on the first device. For example, when the endpoint 102 and the audio device 104 are paired, the endpoint 102 may output an indication that the endpoint 102 and the audio device 104 have been paired. In some instances, the indication may be output via the display 202 and/or the speaker(s) 200 of the endpoint 102.

Although the process 800 illustrates pairing the endpoint 102 with a single audio device 104, the endpoint 102 may be paired with other audio devices 104. In such instances, the same series of prompt(s) 114 or a different series of prompt(s) 114 may be output on the endpoint 102. Further, some of the audio devices 104 may be paired using the ultrasonic signals 112, while some of the audio devices 104 may be paired using the series of prompt(s) 114.

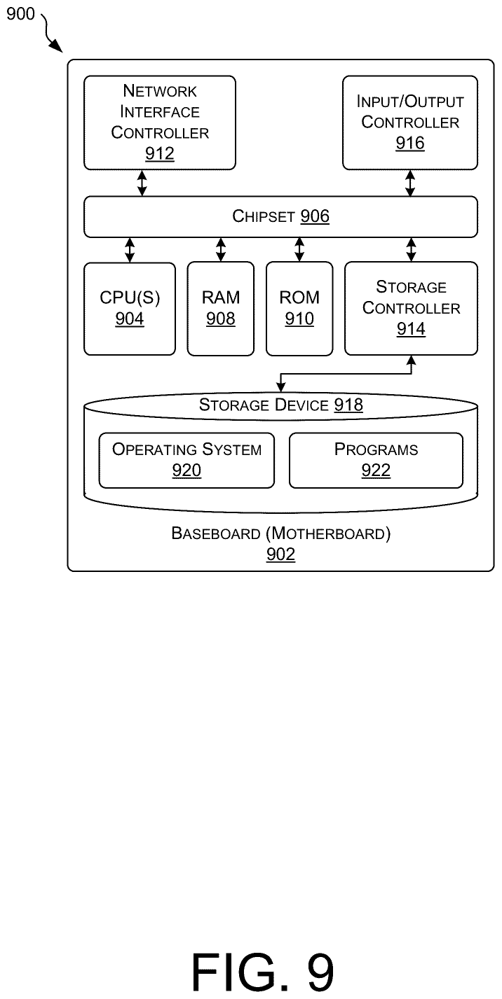

FIG. 9 illustrates an example computer architecture for a computing device 900 (or network routing device) capable of executing program components for implementing the functionality described above. The computer architecture shown in FIG. 9 illustrates a conventional server computer, workstation, desktop computer, laptop, tablet, network appliance, e-reader, smartphone, or other computing device, and may be utilized to execute any of the software components presented herein. The computing device 900 may, in some examples, correspond to a physical server of a data center, or the endpoint 102 as described above.

The computing device 900 includes a baseboard 902, or “motherboard,” which is a printed circuit board to which a multitude of components or devices may be connected by way of a system bus or other electrical communication paths. In one illustrative configuration, one or more central processing units (“CPUs”) 904 operate in conjunction with a chipset 906. The CPUs 904 may be standard programmable processors that perform arithmetic and logical operations necessary for the operation of the computing device 900.

The CPUs 904 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 906 provides an interface between the CPUs 904 and the remainder of the components and devices on the baseboard 902. The chipset 906 may provide an interface to a RAM 908, used as the main memory in the computing device 900. The chipset 906 may further provide an interface to a computer-readable storage medium such as a read-only memory (“ROM”) 910 or non-volatile RAM (“NVRAM”) for storing basic routines that help to startup the computing device 900 and to transfer information between the various components and devices. The ROM 910 or NVRAM may also store other software components necessary for the operation of the computing device 900 in accordance with the configurations described herein.

The computing device 900 may operate in a networked environment using logical connections to remote computing devices and computer systems through a network, such as the network(s) 108. The chipset 906 may include functionality for providing network connectivity through a network interface controller (NIC) 912, such as a gigabit Ethernet adapter. The NIC 912 is capable of connecting the computing device 900 to other computing devices over the network(s) 108. It should be appreciated that multiple NICs 912 may be present in the computing device 900, connecting the computer to other types of networks and remote computer systems.

The computing device 900 may be connected to a storage device 918 that provides non-volatile storage for the computing device 900. The storage device 918 may store an operating system 920, programs 922, and data, which have been described in greater detail herein. The storage device 918 may be connected to the computing device 900 through a storage controller 914 connected to the chipset 906. The storage device 918 may consist of one or more physical storage units. The storage controller 914 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 900 may store data on the storage device 918 by transforming the physical state of the physical storage units to reflect the information being stored. The specific transformation of physical state may depend on various factors, in different embodiments of this description. Examples of such factors may include, but are not limited to, the technology used to implement the physical storage units, whether the storage device 918 is characterized as primary or secondary storage, and the like.

For example, the computing device 900 may store information to the storage device 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 900 may further read information from the storage device 918 by detecting the physical states or characteristics of one or more particular locations within the physical storage units.

In addition to the mass storage device 918 described above, the computing device 602 may have access to other computer-readable storage media to store and retrieve information, such as program modules, data structures, or other data. It should be appreciated by those skilled in the art that computer-readable storage media is any available media that provides for the non-transitory storage of data and that may be accessed by the computing device 900. In some examples, some or all of the operations performed by the computing device 900, and or any components included therein, may be performed by one or more computing device(s) operating in a cloud-based arrangement.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 918 may store an operating system 920 utilized to control the operation of the computing device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system may comprise the UNIX operating system or one of its variants. It should be appreciated that other operating systems may also be utilized. The storage device 918 may store other system or application programs and data utilized by the computing device 900.

In one embodiment, the storage device 918 or other computer-readable storage media is encoded with computer-executable instructions which, when loaded into the computing device 900, transform the computer from a general-purpose computing system into a special-purpose computer capable of implementing the embodiments described herein. These computer-executable instructions transform the computing device 900 by specifying how the CPUs 904 transition between states, as described above. According to one embodiment, the computing device 900 has access to computer-readable storage media storing computer-executable instructions which, when executed by the computing device 900, perform the various processes described above with regard to FIGS. 5-8. The computing device 900 may also include computer-readable storage media having instructions stored thereupon for performing any of the other computer-implemented operations described herein.

The computing device 900 may also include one or more input/output controllers 916 for receiving and processing input from a number of input devices, such as a keyboard, a mouse, a touchpad, a touch screen, an electronic stylus, or other type of input device. Similarly, an input/output controller 916 may provide output to a display, such as a computer monitor, a flat-panel display, a digital projector, a printer, or other type of output device. It will be appreciated that the computing device 900 might not include all of the components shown in FIG. 9, may include other components that are not explicitly shown in FIG. 9, or might utilize an architecture completely different than that shown in FIG. 9.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application

What is claimed is:

1. A method comprising:
causing output of a signal via a first device within an environment, the first device being connected to a network;
receiving, from a second device within the environment, first data associated with the signal, the second device being connected to the network;
determining a similarity between the signal represented within the first data and the signal output from the first device;
determining that the similarity satisfies a threshold;
determining, based at least in part on the similarity satisfying the threshold, to pair the first device and the second device;
receiving, from the second device, second data associated with speech captured within the environment; and
sending, over the network and to a third device remote from the environment, third data associated with the speech.

2. The method of claim 1, further comprising:
receiving, from a fourth device within the environment, fourth data associated with the signal, the fourth device being connected to the network; and
determining, based at least in part on the fourth data, to pair the first device and the fourth device.

3. The method of claim 1, wherein:
the signal includes at least one of:
a first device identifier of the first device,
a first IP address of the first device, or
a first media access control (MAC) address of the first device;
the first data includes at least one of:
the first device identifier,
the first IP address,
the first MAC address,
a second device identifier of the second device,
a second IP address of the second device, or
a second MAC address of the second device; and
at least one of the first device identifier, the first IP address, the first MAC address, the second device identifier, the second IP address, or the second MAC address is used to route the first data from the second device to the first device over the network.

4. The method of claim 1, further comprising:
causing output of one or more prompts via a display of the first device;
receiving, from a fourth device within the environment, fourth data associated with one or more inputs provided to a button of the fourth device, the fourth device being connected to the network;
determining a second similarity the one or more inputs and the one or more prompts;
determining that the second similarity satisfies a second threshold; and
determining, based at least in part on the second similarity satisfying the second threshold, to pair the first device and the fourth device.

5. The method of claim 1, wherein one of:
the first device includes a Bluetooth radio and the signal is a Bluetooth token;
the first device includes an ultrawideband (UWB) radio and the signal is an UWB signal; or
the first device includes a speaker and the signal is an ultrasonic signal.

6. A first device comprising:
a display;
a speaker;
one or more processors; and
one or more computer-readable media storing computer-executable instructions that, when executed by the one or more processors, cause the one or more processors to perform operations comprising:
determining a device type of a second device within an environment of the first device,
based at least in part on the device type, one of:
causing, via the speaker, output of first audio, or
causing, via the display, output of one or more prompts associated with providing input to an input component of the second device,
receiving, via a network, data associated with one of:
second audio captured at the second device, or
the input provided to the input component of the second device, and
determining, based at least in part on the data, to associate the first device and the second device.

7. The first device of claim 6, the operations further comprising receiving, via the network, second data associated with third audio captured at the second device.

8. The first device of claim 7, wherein:
the first audio is associated with audio that is at or above 20 kilohertz (kHz); and
the third audio is associated with audio that below 20 kHz.

9. The first device of claim 6, wherein the one or more prompts include at least one of:
a first indication associated with a first instance in time at which to provide the input to the input component;
a second indication associated with an amount of time to provide the input to the input component; or
a third indication associated with a second instance in time at which to release the input to the input component.

10. The first device of claim 6, wherein the second device is connected to the network via power over ethernet (POE).

11. The first device of claim 6, wherein determining to associate the first device and the second device includes:
at least one of:
determining a first similarity between the first audio output by the first device and the second audio captured at the second device, or
determining a second similarity between the one or more prompts output on the first device and the input provided to the input component of the second device; and
determining that the first similarity or the second similarity is greater than a threshold similarity.

12. The first device of claim 6, the operations further comprising:
receiving, via the network, second data associated with third audio captured at a third device in the environment, and
determining, based at least in part on the second data, to associate the first device and the third device.

13. The first device of claim 6, the operations further comprising:
causing, via the display, output of one or more second prompts associated with providing second input to a second input component of a third device within the environment;
receiving, via the network, second data associated with the second input provided to the second input component of the third device; and
determining, based at least in part on the second data, to associate the first device and the third device.

14. The first device of claim 6, wherein:
the first audio includes at least one of:
a first device identifier of the first device,
a first IP address of the first device, or
a first media access control (MAC) address of the first device; and
the data includes at least one of:
the first device identifier,
the first IP address,
the first MAC address,
a second device identifier of the second device,
a second IP address of the second device, or
a second MAC address of the second device.

15. A method comprising:
determining, via a first device within an environment, a device type of a second device within the environment;
determining, based at least in part on the device type, to output first data via the first device;
causing output of the first data;
receiving, via a network, second data from the second device, the second data being associated with:
audio generated via a microphone of the second device,
an input provided to an input component of the second device, or
a signal received via a radio of the second device; and
determining, based at least in part on the first data and the second data, to pair the first device and the second device.

16. The method of claim 15, wherein one of:
the first data is output via a speaker of the first device and is associated with audio above 20 kilohertz (kHz);
the first data is output via a display of the first device and is associated with one or more prompts to provide the input to the input component; or
the first data is output via a radio of the first device and includes a device identifier of the first device.

17. The method of claim 16, wherein the one or more prompts include at least one of:
a first indication associated with a first instance in time at which to provide the input to the input component;
a second indication associated with an amount of time to provide the input to the input component; or
a third indication associated with a second instance in time at which to release the input to the input component.

18. The method of claim 15, wherein the second data includes at least one of:
a first device identifier of the first device;
a first IP address of the first device;
a first media access control (MAC) address of the first device;
a second device identifier of the second device;
a second IP address of the second device; or
a second MAC address of the second device.

19. The method of claim 15, further comprising:
receiving, via the network, third data from a third device within the environment, the third data being associated with second audio captured at a second microphone of the third device or a second input provided to a second input component of the third device;
determining a second similarity between the first data and the third data; and
determining, based at least in part on the second similarity, to pair the first device and the third device.

20. The method of claim 15, wherein the second device is connected to the network via power over ethernet (POE).
